(19) United States
(12) Patent Application Publication
(10) Pub. No.: US 2008/0235223 A1
(43) Pub. Date: Sep. 25, 2008

(54) Online compliance document management system

(76) Inventors: Donald Douglas, Golden, CO (US); Greg Skufca, Littleton, CO (US)

Correspondence Address: SCOTT L. TERRELL, P.C., STE E, 12970 W. 20TH AVE., GOLDEN, CO, 80401, US

(21) Appl. No.: 11/725,225

(22) Filed: Mar. 19, 2007

(51) Int. Cl. G06F 17/30

(52) U.S. Cl. 707/6

(57) ABSTRACT

A method for a performing a real time audit of compliance statistics is provided which includes storing a plurality of compliance items into a database, inputting a job application for an employee having a job designation and a work location, using the job designation, work location, and compliance items to determine a collection of required compliance items, collecting the required compliance items into a record and storing the record into a file, inputting a compliant item into the file, using the required compliance items and the compliant items to determine a compliance statistic for the employee, work location, compliance items, and compliant items, and outputting the compliance statistic.

### CROSS REFERENCE TO RELATED APPLICATIONS

Not Applicable.

### BACKGROUND OF THE INVENTION

1. Field of the Invention

The present invention relates to online compliance management systems. In particular, it relates to an online compliance management system using a job designation, work location, and document file to determine a real time compliance statistic for an entity, location, employee, and compliance item.

2. Description of the Related Art

It is well known in the art, that verifying the timely and accurate completion of work location, and job designation specific compliance items is a costly and time consuming process which requires hundreds of man hours in the preparation, completion, and filing of forms and tests for submission to authorities in a compliance audit. It is also well known, that even after the preparation, completion, and filing of compliance documents that a relative degree of inaccuracy exists as to whether or not the documents are in fact compliant and are on file with the facility, its locations, and employees at audit time because of human error experienced in the review of the documents by staffing professionals. An alternative is to provide a method, or system, which uses a set of rules to monitor and track compliance for use by the entity, its locations, and employee at audit time. Up until now, few such examples exist.

U.S. Patent Pub. No. 2004/017736 (filed Oct. 18, 2003), to Bibko et al., discloses a WWW based system for allowing an employee or contractor serving at a facility to identify all regulatory requirements applicable to a minor facility, such as environmental regulations, via the WWW without need for expert assistance, and once accomplished to incorporate the regulations into one or more different records, to be made available and used in an audit and thereafter to prompt compliance and assure ongoing compliance with applicable requirements. Here, Bibko, seeks to overcome the need to retain professionals, such as legal professionals, to identify from a WWW source having all legal requirements, such as governmental codes, those legal requirements applicable to a specific facility by converting them into templates and to build, from the templates, compliance record checklists, for distribution to assigned employees and contractors for completion. On going compliance is monitored through scheduling the completion of compliance items from the list.

In another example, U.S. Patent Pub. No. 2004/0243428 (filed May 19, 2004), to Black et al., discloses a Web-based system for human resources management by generating employment forms which are continuously updated to reflect changes in the applicable laws that correspond to the hiring requirements of the client. This system drives employer compliance with applicable human resources laws. The forms are presented to the client for completion in a sequence that is determined using timed legal criteria to ensure compliance with rules of law. For example, this system would require a conditional offer form to be generated and received by the client prior to the generation of a form for the client to consent to a background check.

In another example, U.S. Patent Pub. No. 2004/0162844 (filed Aug. 19, 2004), to Thome et al., discloses an online compliance management system and method that allows trucking companies and carriers to enhance the efficiency of their operation. This method is used to receive data from an individual, make a rule application of the individual's data with operational requirements, and to notify an entity if the individual's data does not comply with the operational requirements.

In yet another example, U.S. Patent Pub. No. 2003/0153991 (filed Jul. 22, 2002), to Visser et al., discloses a compliance management system implemented in a client-server network where a responsible representative is assigned and notified of an out-of-compliance status and compelled to perform corrective actions through repeated and successive notification until compliance is achieved. If any of the elements remain out-of-compliance then the responsible representative is again notified of the status and is required to indicate that the element is if fact compliant, otherwise the process ends.

While the foregoing examples offer some utility, a major disadvantage in each lies in the fact that, while they do provide for monitoring the compliance of facilities or employees with a list of compliance items, they require a review of the listed items by a responsible representative to determine whether the items have been completed which can result to errors in reporting, rather than automatically monitoring actual compliance documents on file within the system to ensure compliance, which allows for employees to be out of compliance when the system shows that they are in compliance. The foregoing examples also do not provide for a real-time determination of overall compliance statistics for a facility, location, employee or document type based on an applicant's job designation and work location. Thus, it is desirable to provide a system which accurately monitors the completion and file management of compliance documents and tests for a facility, work location, and its employees, through the use of an online employment application having a job designation and work location, but which is easy to use, inexpensive and allows an employer to free up its staff by allowing them to view its compliance performance in relation to a percentage of completed compliant documents on file as a record in the system. It is also desirable to provide a system which is customizable to meet the particular needs of the administrator. The present invention satisfies these needs.

### BRIEF SUMMARY OF THE INVENTION

It is therefore an object of the present invention to provide an on-line real-time determination of a compliance statistic for a facility, its locations, employees and/or document types based on an applicant's job designation, designated compliance item, and work location.

It is another object of the present invention to provide a system which accurately monitors compliance through the actual filing of compliant documents and tests for a facility, work location, and its employees.

It is another object of the present invention to provide a compliance document management system that is easy to use and allows an employer to free up its staff by allowing them to view its compliance statistics in relation to a percentage of compliant documents or tests on file.

It is another object of the present invention to provide a compliance document system that monitors, notifies and reports ongoing compliance in real-time for a facility, its locations, employees, and document types by job designation, location, and compliant document types in an employee's file.

It is yet another object of the present invention to provide a compliance document management system which is customizable by the end user to meet one's particular needs.

To overcome the problems of the prior art methods and in accordance with the purpose of the invention, as embodied and broadly described herein, briefly, a method for a performing a real time audit of compliance statistics is provided which includes storing a plurality of compliance items into a database, inputting a job application for an employee having a job designation and a work location, using the job designation, work location, and compliance items to determine a collection of required compliance items, collecting the required compliance items into a record and storing the record into a file, inputting a compliant item into the file, using the required compliance items and the compliant items to determine a compliance statistic for the employee, work location, compliance items, and compliant items, and outputting the compliance statistic.

Additional advantages of the present invention will be set forth in part in the description that follows and in part will be obvious from that description or can be learned from practice of the invention. The advantages of the invention can be realized and obtained by the invention particularly pointed out in the appended claims.

### BRIEF DESCRIPTION OF THE SEVERAL VIEWS OF THE DRAWINGS

The accompanying drawings, which are incorporated in and which constitute a part of the specification, illustrate at least one embodiment of the invention and, together with the description, explain the principles of the invention.

FIG. 1 is a browser display providing access to information pertaining to the root home page of the present invention.

FIG. 2 is a browser display providing access to information pertaining to the administration configuration of the present invention.

FIG. 3 is a browser display providing access to information pertaining to the client user administration of the present invention.

FIG. 4 is a browser display providing access to information pertaining to the configuration of the client user according to the present invention.

FIG. 5 is a browser display providing access to information pertaining to the configuration of the notification sending preferences according to the present invention.

FIG. 6 is a browser display providing access to information pertaining to the administration of the locations according to the present invention.

FIG. 7 is a browser display providing access to information pertaining to the fax staging area according to the present invention.

FIG. 8 is a browser display providing access to information pertaining to the employee list according to the present invention.

FIG. 9 is a browser display providing access to information pertaining to the employee information according to the present invention.

FIG. 9B is a browser display providing access to information pertaining to the employee online compliance resources according to the present invention.

FIG. 10 is a browser display providing access to information pertaining to the employee online documents resources according to the present invention.

FIG. 11 is a browser display providing access to information pertaining to the employee online testing resources according to the present invention.

FIG. 12 is a browser display providing access to information pertaining to the employee reports configuration according to the present invention.

FIG. 12B is a browser display providing access to information pertaining to the location and hospital reports configuration according to the present invention.

FIG. 13 is a browser display providing access to information pertaining to the selection of employee reports configuration according to the present invention.

FIG. 13B is a browser display providing access to information pertaining to the employee compliance items reports according to the present invention.

FIG. 14 is a browser display providing access to information pertaining to the basic employee compliance report for all items according to the present invention.

FIG. 14B is a browser display providing access to information pertaining to the basic employee compliance report for selected items according to the present invention.

FIG. 15 is a browser display providing access to information pertaining to the configuration of the compliance report for selected locations according to the present invention.

FIG. 15B is a browser display providing access to information pertaining to the configuration of the compliance report for the selected locations and the selected compliance items according to the present invention.

FIG. 16 is a browser display providing access to information pertaining to the locations compliance report for the selected compliance items according to the present invention.

FIG. 17 is a browser display providing access to information pertaining to the configuration of the hospital compliance report according to the present invention.

FIG. 18 is a browser display providing access to information pertaining to the hospital compliance report for the selected compliance items and all employees according to the present invention.

FIG. 19 is a browser display providing access to information pertaining to the online application configuration used in the determination of compliance statistics according to the present invention.

FIG. 20 is a browser display providing access to information pertaining to the online application job types used in the determination of the compliance statistics according to the present invention.

FIG. 21 is a browser display providing access to information pertaining to the online application compliance items used in the determination of the compliance statistics according to the present invention.

### DETAILED DESCRIPTION OF THE INVENTION

Unless specifically defined otherwise, all technical or scientific terms used herein have the same meaning as commonly understood by one of ordinary skill in the art to which this invention belongs. As used herein the term “compliance items” means a database of documents, tests or questionnaires which may be accessed to determine a record of required compliance item. The term “required compliance items” means a record collected from fields of compliance items using a job designation and a work location. The term “compliant item” means a completed, verified or authorized document, test, or questionnaire stored in a file having records of the required compliance items and the compliant items.

although any methods and materials similar or equivalent to those described herein can be used in the practice or testing of the present invention, the preferred methods and materials are now described. Reference will now be made in detail to the presently preferred embodiments of the invention, examples of which are illustrated in the accompanying drawings wherein like numerals represent like features of the invention.

The present invention is useful in the management of medical, food, and other industries, such as those requiring the monitoring immigration status, compliance with local, state, federal, and associational specific rules, regulations, laws and guidelines.

In a preferred embodiment, the compliance module, according to the present invention, is deployed on a general purpose computer in a Word Wide Web (“WWW”) HTML based Web-enabled utility, enabled computer architecture which is accessed through a Graphical User Interface (“GUI”). The computer architecture contains three main components—a central processing unit (“CPU”), main memory, and external (peripheral) devices. The application code for the compliance module is executable on the general purpose computer in a real time (interactive) processing, a program which runs when it is submitted, with user interaction during processing. The computer's main memory is large enough and the CPU is fast enough, to allocate the server main memory among several users running the compliance module applications simultaneously. Through teleprocessing, the server is accessed from a remote station, such as a telephone line, using a modem to convert to/from the digital signals required by the server. In this manner, the server interacts with, and is fed by, the clients or employees smaller computers in other locations. The server and remote location computers are connected to the WWW via any well known communications web enabled browser and hardware. Clients and employees receive and upload information to the system though the GUI, over the Internet using those internet standards and scripting languages well known in the art. A client or employee contacts the computer server, hosting the compliance module, to request or upload compliance documents, or information or access to compliance resources, such as online skills tests and questionnaires. The compliance module server locates and sends the information to the web browser for display of the results.

An employee's documents, online tests and compliance status can be viewed from any computer having an internet access. Documents can be scanned, uploaded or faxed into an employee's online file folder using a variety of input/output devices that feed data to, or receive data from the computer. Such devices include terminals, jump drives, digitizers, printers and plotters, tape and disk drives, optical character readers, facsimile machines and scanners. The input/output devices are used to create a collection of fields or a record. For example, the name, age, address, job designation and work location for an employee are fields in an application record.

Groups of records are stored in an employee's or client file. A random (direct access) file structure, may be provided where any record can be accessed without starting at the beginning of the file. File indexing is provided to keep the names of documents, skills tests and questionnaires in order. Sorting routines are also provided to place data in ascending or descending numerical or alphabetical order.

Employees take the required tests and complete skills check lists online, at their convenience, on a computer or at the employer's facility. The system automatically builds a table of online compliance items for each employee based on their career designation specialty and the location of where they work within the employer's organization. After their documents and tests are available online, the employer can obtain a variety of up-to-date compliance reports at its convenience. By performing a real-time audit of the compliance items on file within the system, the employer is provided with a reassurance that its compliance documents have been completed and are on file, in order to determine and monitor compliance.

In one aspect of the invention, the system uses a facsimile process to facilitate the transition to a paperless employee compliance file. The system is designed to accept, via facsimile transmission, an entire folder of compliant documents. The administrator faxes in the compliant documents to a previously registered telephone number which is a client specific staging area. The administrator then provides employee file destination information for each document, and is then is able to view the document in an employees file.

In yet another aspect of the invention, rather than to maintain the employee's compliance file on a server, the employee uploads the compliant documents directly into a compliance file folder, having the required compliance items, stored in the employee's remote location computer. The required compliance items are compared and matched to the compliant items to determine the compliance statistic. The administrator may then, but need not, provide an authentication stamp or digital signature for each document to ensure that it is indeed compliant. In this manner, the employee or administrator is able to view the compliant document stored in the employee's remote computer file and directly submit the compliant document to compliance auditors for their review, acceptance, and determination of overall compliance. This method of filing frees the server for other uses and allows the employee to upload compliance items into the compliance file without access to the WWW.

In addition to viewing documents for each employee's page, the user can select the file cabinet tab to browse through all of the uploaded documents that are filed within the system. In this manner, a virtual file cabinet is created which eliminates the limitations, need, and costs of a paper storage system. A user can view any number of files which are sorted by employee, by office location, and by document type. A search function is provided for the user to quickly locate one file from thousands using keywords specific to the file in question. Through monitoring of actual compliant documents contained within the file as a function of required compliance documents the risk of human error is greatly reduced.

One feature of the present invention, includes an automatic out-of-compliance notification. Here, once an employee's files have been completed, and they are deemed compliant, the system automatically keeps users informed of any compliance breach by sending them an e-mail notification. Thus, by letting the user know in advance notification of the time when time-sensitive-documents will be expiring, the system prevents specific employees from being out of compliance. This is eliminates the need, and is an improvement over the prior art, of having a responsible person on the employer's staff checking every document, in every employees file, on each day.

Beyond the standard notifications built into the system, the system also allows the user to create customer reports, contrast compliance rates for entities employees, compare test results by office location, or view upcoming document expiration dates in order to schedule a training class. Reminders may be through scheduled reports to run as periodic email notifications. Every report run can be sent by e-mail or downloaded directly for printing. The documents found in the report can be optionally included as an attached Portable Document Format (PDF) document or compressed ZIP file.

The system is customizable to suit an entity's individual needs. Since compliance requirements can vary from office location to office location the administrator can create a location tree to reflect an individual organizational structure. The system is flexible so as to define compliance items, user permissions, and employee documents for each location. The system also includes an embedded library of job type description data, document types and document tests which are preloaded in the system. If an entity has additional requirements its site can be easily customized by the end user to accommodate those needs. A test editor is provided to also allow the user to create tests, questionnaires, and skills checklists. Employees are then able to keep up to date by accessing their own files, and taking their own tests online.

### EXAMPLE

The following example is for a medical employee on-line medical management system. In use, staffing professionals, or persons responsible for an entire hospital, have a need for the compliance tracking, on-line testing and document management necessary for JCAHO certification or other state or regulatory requirement. This system provides an efficient and economical means by which health care providers can stay compliant to remediate competency tests for their many employees in a wide range of job designations. It keeps real time track of compliance issues for the employee and locations by documents types, and warns a client or employee of issues prior to a time when they become a problem. For employee management, the employee's documents, online tests and compliance status are viewed from any computer having internet access by using the pointing device and clicking on the Employees tab, of the browser display. Documents are scanned and uploaded or faxed into the user's employee's online file folder. The file folder display illustrates the employee by first name, last name, activity status, percent compliant and job designation. The user then clicks on an employees name to view the employee's personal data, career designation(s), office location and online employee resources including links to online documents, online testing (skills tests, questionnaires, and skills checklists), and an compliance information table of uploaded documents. Employees take the required tests and complete skills check-lists online. The management system automatically generates a database of compliance items for each employee based on their career specialty and the location of where they work within a client's hospital. By performing a real-time audit of those compliant items actually filed and completed relative to those compliance items which are required, according to the specific employees' job designation and location, the system reports a compliance percentage which provides a high degree of accuracy at audit time.

An online filing cabinet is an important aspect of the invention. The system ensures an accurate compliance report by comparison of compliant documents uploaded into an employee's file with compliance items to be completed based on the job designation and location. In addition to viewing documents for each employee's page, the user or employee can browse or search through all of the uploaded compliant documents, on record within the system, and file cabinet. By simply pointing and clicking on the file identifier or entering a search string, the client or employee can view any number of files sorted by an employee, office location, or document type.

Reports and notifications are also provided. In this example, a summary of the overall compliance percentage, total number of employees, number of compliant employees, and non-compliant employees for a medical office is displayed. A compliance percentage for each employee at the office is also displayed. Once an employee's files are complete and they are deemed compliant, the system automatically keeps the entity informed of any compliance breach by sending it an email notification with information in advance relating to when documents will be expiring. In this manner, the system prevents entities and its employees from being out of compliance. This is the equivalent of having a responsible person on staff check every document in every employees file, each day.

Beyond the standard notifications built into the system, it also allows the instructor or user to create custom reports, contrast compliance rates for its employees, compare test results by location, and to look at upcoming document expirations, to schedule a training class. For example, a simple compliance report may be displayed for a Post-Anesthesia Care Unit, Registered Nurse, showing the number of compliance items, compliant items, and a compliance average. The system provides a screen shot which enables the user to configure the reports in order to run a saved report, create a report for a template, and to view upcoming expirations. The user can also schedule reports to run as periodic email notifications.

The system is customizable to suit a client's individual needs. Since compliance requirements can vary from location to location, a location tree is provided to reflect an organizational structure. For example, an organization, such as a hospital, may include a tree identifying its East, West, and North facilities. The user has the ability to define compliance items, user permissions, and employee documents for each location, such as an age appropriate care test, breathe alcohol test, or an annual TB questionnaire. It is within the scope of the present invention, to include a database of job types, document types and document tests uploaded into the system. If additional compliance items are required, such as questions relating to a medical code of conduct, in the invention is easily customized by the end user to accommodate those needs. A test editor is provided to allow the user to create tests, questionnaires, and skills checklists. Employees are able to keep up-to-date by accessing their own files, and taking tests online.

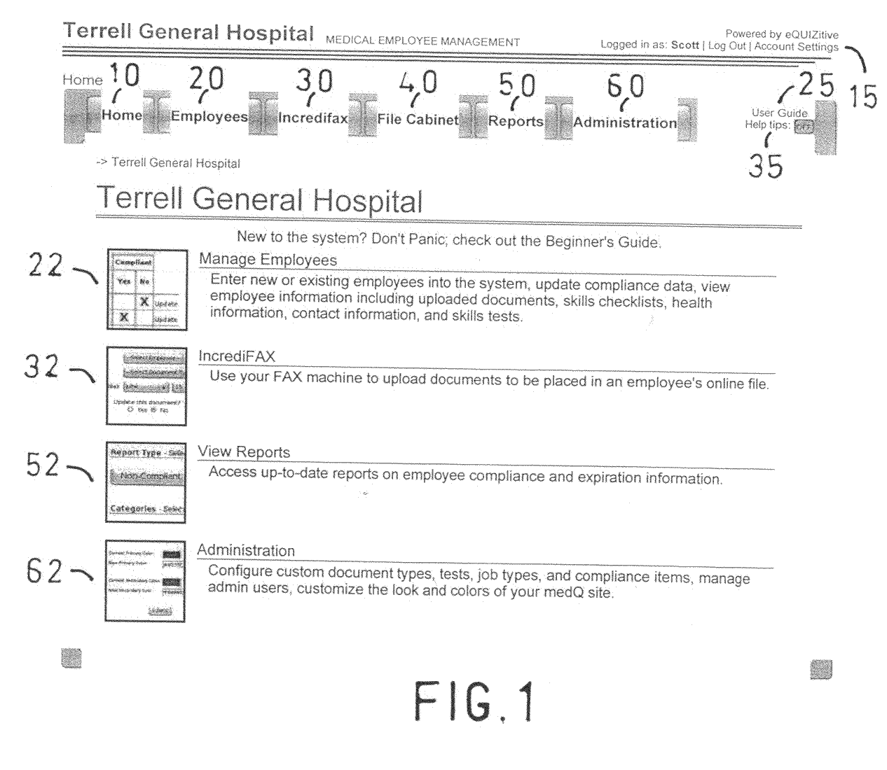

Referring now to FIG. 1, the Home Page for a General Hospital (“Hospital”), using the pointing device, a user accesses the compliance application by opening a browser on a computer and addresses the Web browser to a specific URL. Typical users are hospital administrators or employees, of a client entity, that access the system to perform a variety of tasks. The user then logs on with a user identification and password. The browser window provides the user with GUI interfaces in accordance with the Web Browser. Using conventional GUI interface devices, such as the title bar, toolbars, pull-down menus, tabs, scroll bars, context help, dialog boxes, operating icons, buttons, status bar and others, in the browser display the user navigates throughout the displays, bringing other displays in focus. The tabs gain access to the different areas of employee compliance content such as Home 10, Employees 20, Incredifax 30, File Cabinet 40, Reports 50 and Administration 60. The Home Page 10 appears in the browser window with a toolbar that includes Account Settings 15, User Guides 25, and Help tips 35. Operating icons are provided to navigate through the beginners guide to manage employees 22, upload documents by facsimile 32, view reports 52, and for administration of the system 62. The administration icon 62 is used to automatically access the administration display in the browser window.

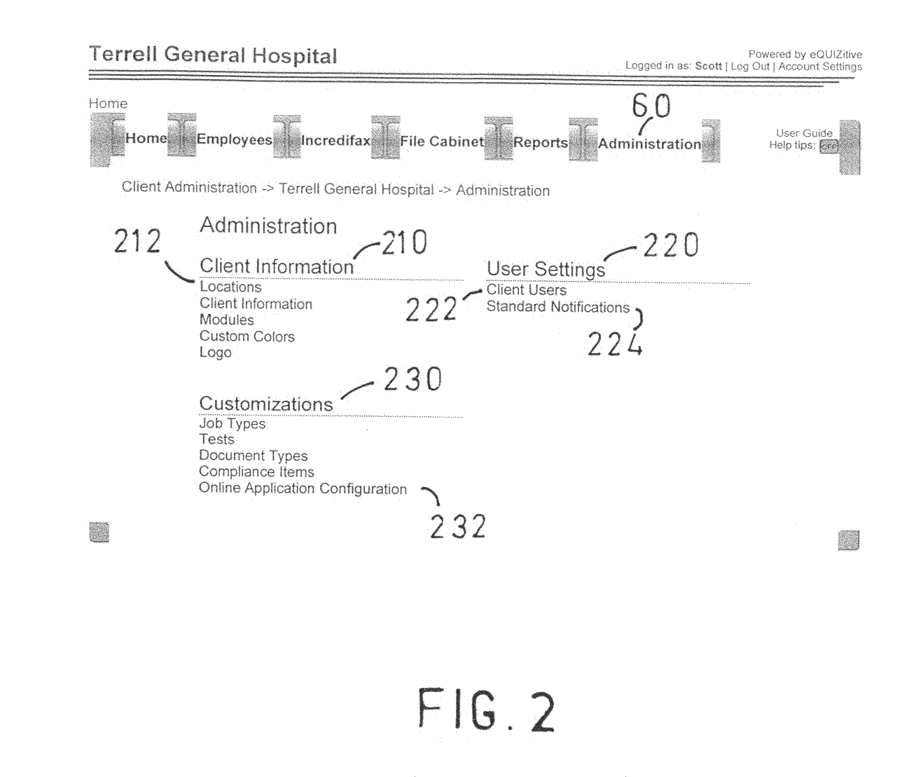

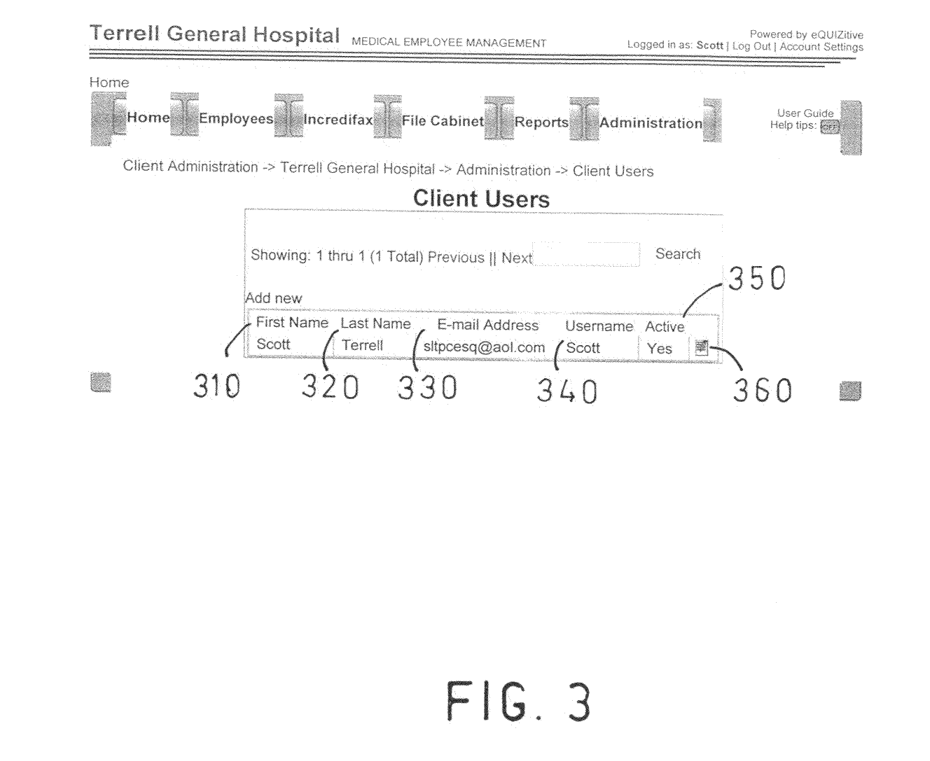

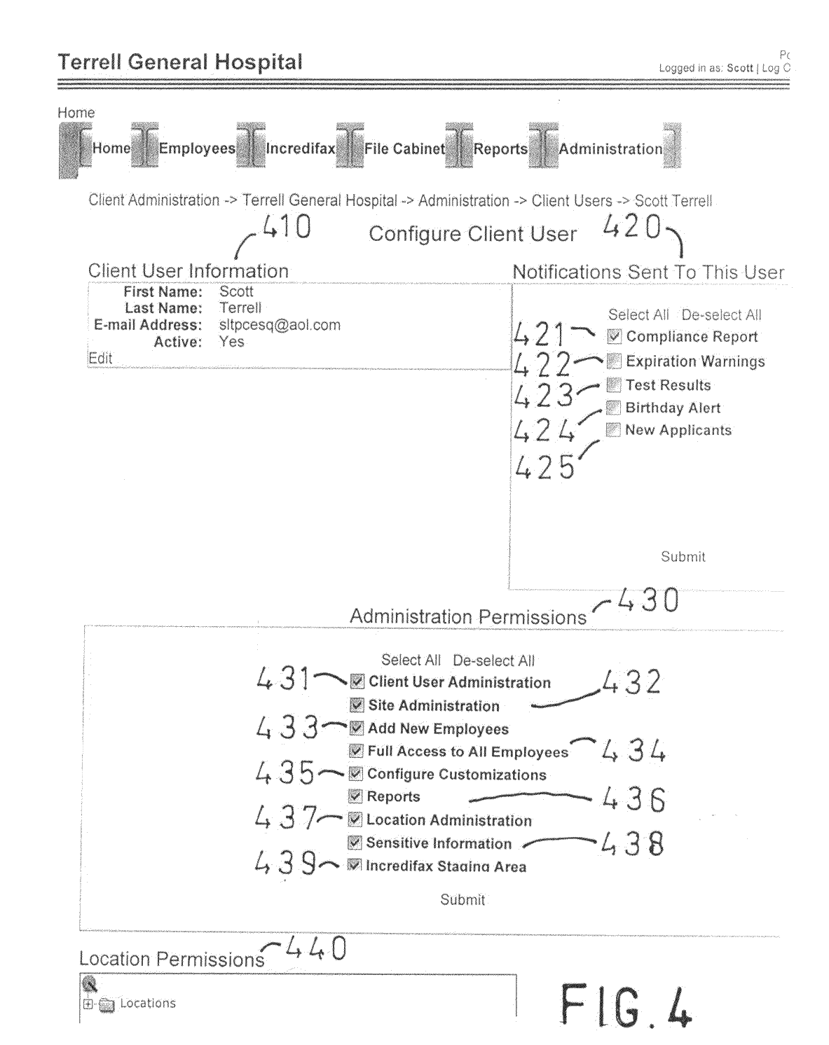

As shown in FIG. 2, the client clicks on the Administration tab 60 to access the administration display information. Here, headings include client information 210, user settings 220 and customizations 230 within the system. Under each heading, the client is able to configure the types of information desired for customizing the system. For example, in order to customize the client users, the client would point and click on the client users 222, in the link list under the user settings 220 heading, to access the display information shown in FIG. 3. Here, the client user information is displayed in the browser window including the first 310, and last 320 names, e-mail address 330, user names 340, and a status bar 350 indicating whether the client user is active. By pointing to, and activating, the configure button 360 next to the active status bar 350, access to the configure client user information is displayed in the browser window shown in FIG. 4. On this display, the client user information 410, notifications to be sent to this user 420, and administration permission 430 headings, are displayed. The client user information 410 includes an edit link for changing the client user information, such as passwords and usernames. Under the heading for notifications to be sent to this user, the user has the ability to select or deselect check boxes for compliance reports 421, expiration warnings 422, test results 423, birthday alerts 424, and for new applicants 425. Under the heading for administration permissions 430, the user is may select or deselect permissions for the client user administration 431, site administration 432, to add new employees 433, for full access to all employees 434, to configure customizations 435, administer reports 436, locations 437, for sensitive information 438, and for access to the facsimile staging area 439. A location permissions tree 440 is also provided in order to customize the above permissions to a single work location for an entity.

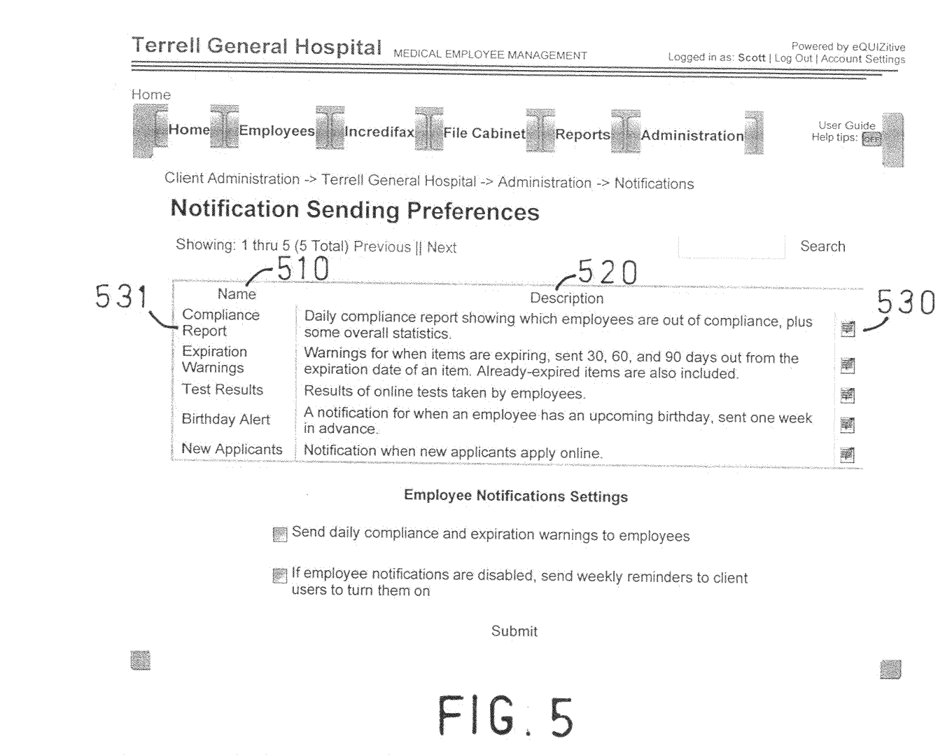

Referring again to FIG. 2, the user may point and click to a standard notifications link 224 which displays the notifications sending preferences, shown in FIG. 5. As shown in drawing figure, the name 510, and description 520 columns of the desired notifications are displayed in a link list. A button 530 is provided, adjacent to each item in the list, for the user to point and click for selection of the specific notifications that the user wishes to receive. For example, the user may, using the pointing device, click on the button 530 in the compliance report name 531 column to link access to information pertaining to a list of the client users who will receive this notification.

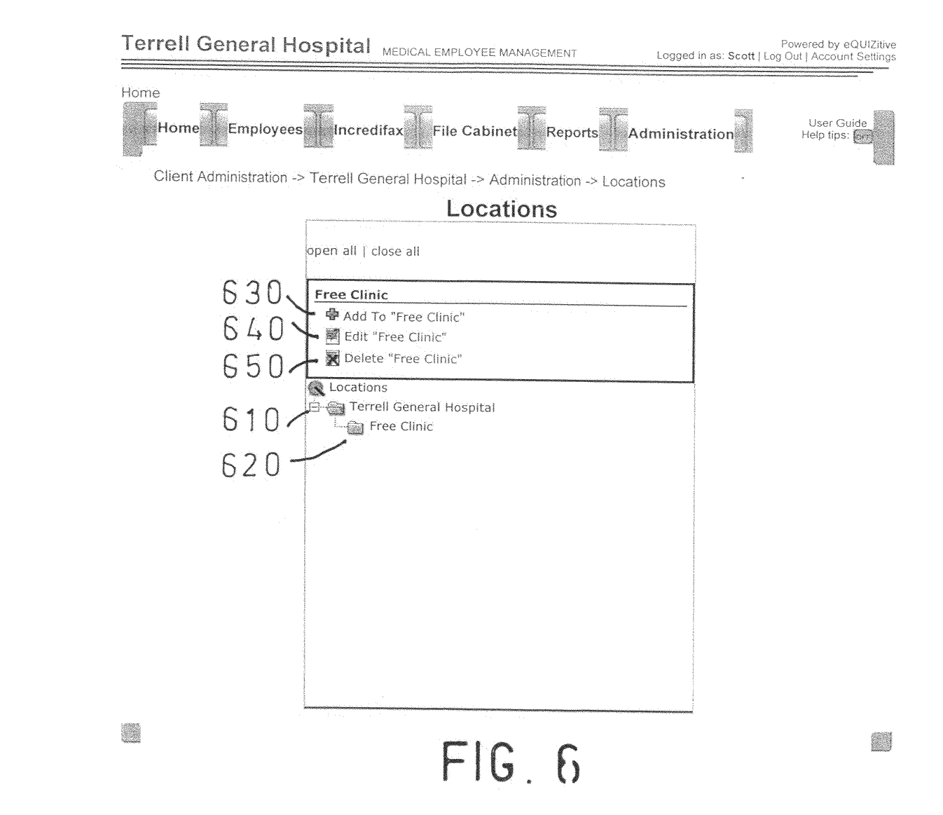

A function in the determination of the real time compliance statistics, of the present invention, is location data. Under the heading for access to client information 210, of FIG. 2, the user may point and click on the locations 212 link, under the client administration heading 210, to view information in the browser display, as shown in FIG. 6. Here, the hospital entity check box 610 provides access to information relating to the user's Free Clinic location. The user may point and click on the Free Clinic file folder icon 620 to display icons used to add 630, edit 640, or delete 650 the Free Clinic, as a location. In this manner, the user may update to new locations to determine of compliance statistics which are specific to the client entity, employees, or any one of its locations based on the actual compliant documents on file within the system for each of the employees working at the Free Clinic location.

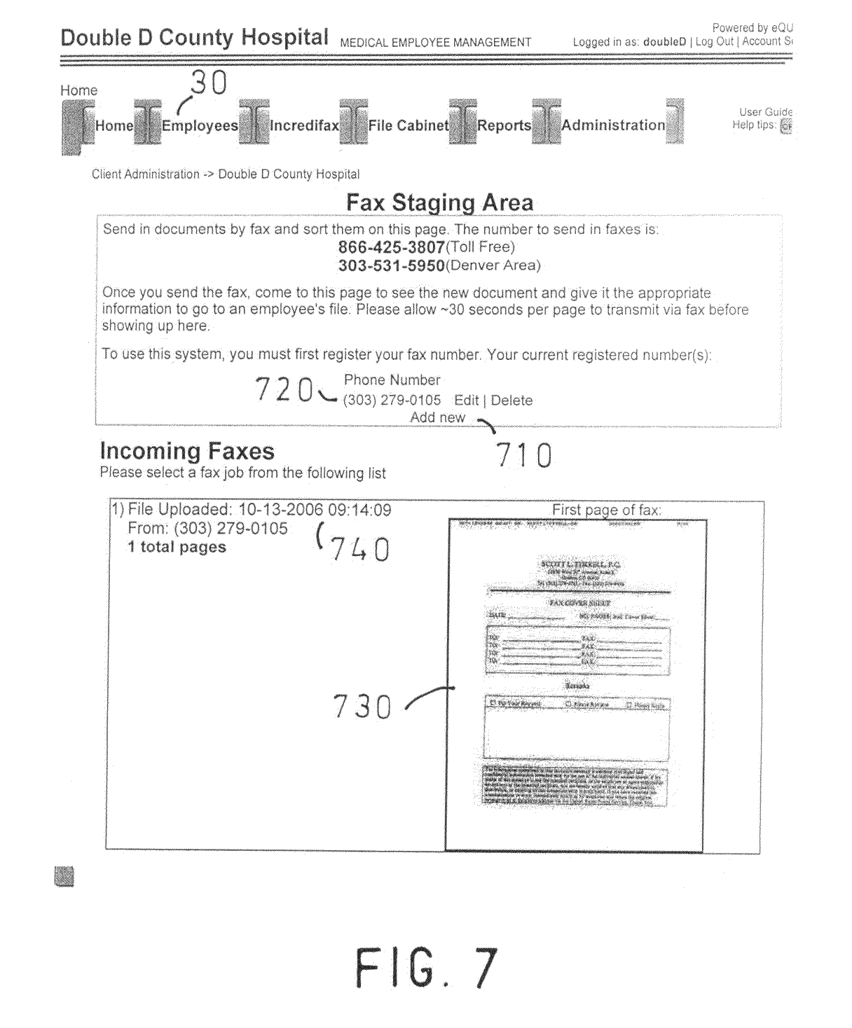

Audit time is greatly reduced and user errors are reduced through a comparison of the verified or completed compliant documents on file, in an employee's file cabinet, with those required compliance documents collected according to each employee's job designation and location in the employment application. In this manner, unless an actual compliant item actually exists in the file, it will be determined as a non-compliant required compliance item and will not included in the calculation of the compliance statistics until it is completed or verified and then uploaded into the filing cabinet. The compliant documents may be input using any method well known in the art, such as scanning into a pdf file, but, in a preferred embodiment, the documents are input using a facsimile transmission, a registered facsimile telephone number, and an entity specific facsimile staging area identified by the telephone number. Using the pointing device, the user clicks on the Incredifax tab 30, of the browser display, to access information pertaining to the facsimile staging area for the hospital. As shown in FIG. 7, to use this method for uploading compliance documents into an entities staging area, the user, such as an employee, first must register their fax number by point and clicking on the new number add 710 browser page link and then entering the requested information. Once registered, the user's registered facsimile number 720 is displayed and all facsimile transmissions incoming from the registered number are routed to the Hospital's staging area for administration and filing by the user. For example, as shown in FIG. 7, a transmission from the number 279-0105 directs a one-page fax 730 to the hospital's staging area and displays the date and time 740 of the document uploaded. The administrator then is able to direct the facsimile image to any employee's file cabinet to ensure that it is used as a compliant item in the calculation of compliance statistics for the employee, location, entity or document type.

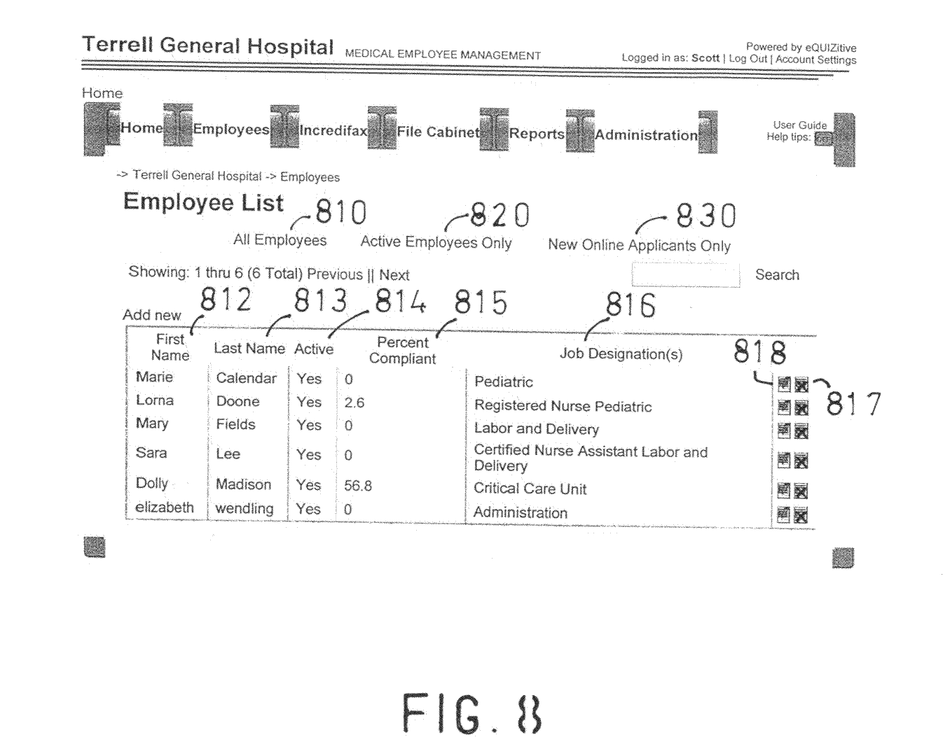

Users are able to access employee compliance information. By point and clicking on the Employees tab 20, the browser display for access to information pertaining to the employee list of the hospital is shown in FIG. 8. Here, under the heading for the employee link list, the user may choose to point and click on sorting routines to list either all employees 810, active employees only 820, or new online applicants only 830. For each list, the employees are identified by first name 812, last name 813, the employment status 814, their percent compliance statistic 815, and job designation 816. Using the pointing device, the user clicks on the heading for each column to toggle a file sort routine for each column in the list. For example, a user may point and click on the percent complaint column heading 815, in order to sort the list from the smallest percentage of compliant employees to the largest. In this manner, the user may easily view problems with employees or job designations. For each line item in a row, icon buttons are selected in order for the user to accesses information pertaining to the deletion of an employee 817 (to inactive status) or to access 818 each employee's information and online resources. For example, by clicking on the icon 818, employee information and online resources for employee Madison are displayed in the browser window.

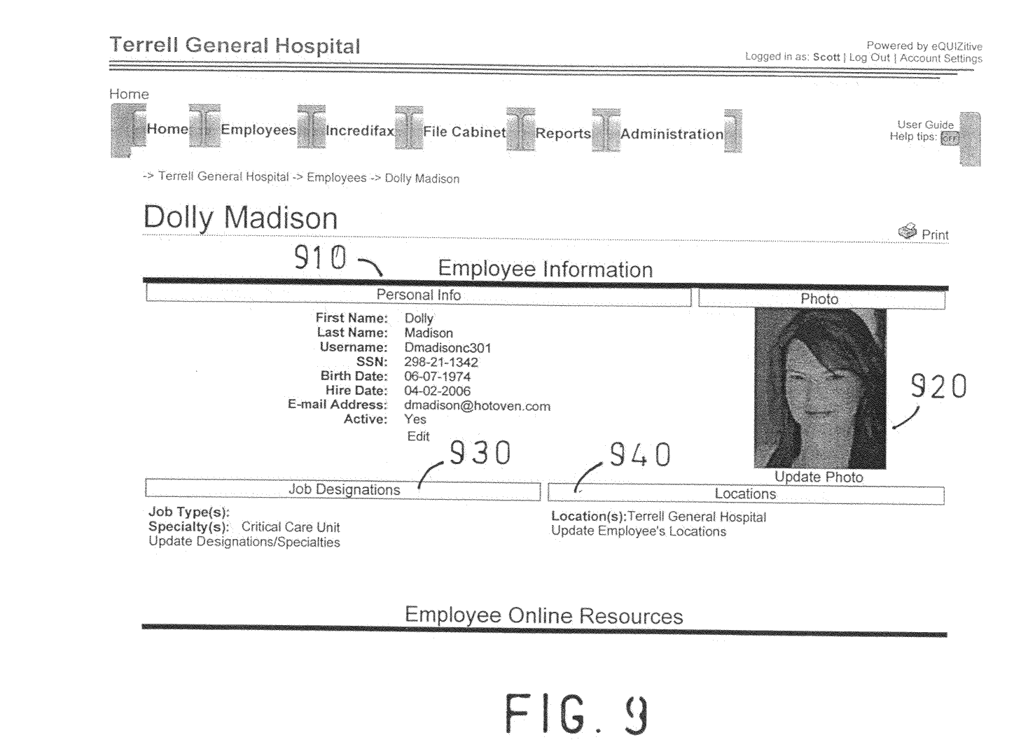

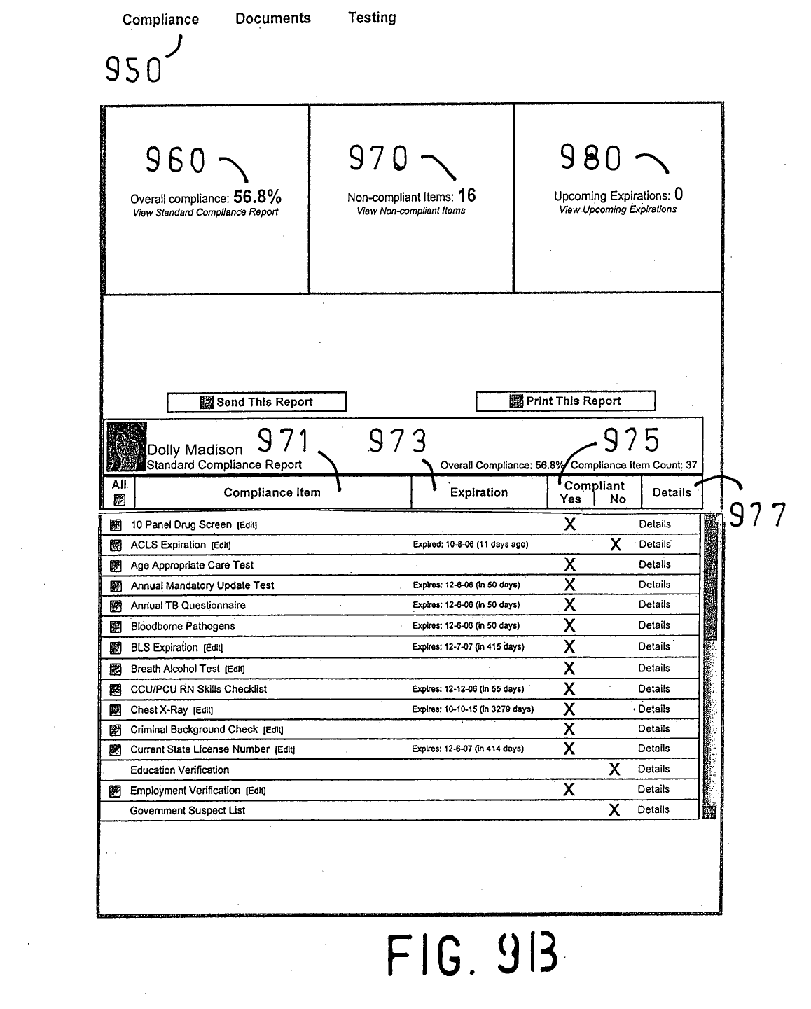

Referring now to FIGS. 9 and 9B, the current employee's personal information 910, security photograph 920, job designations 930, and locations 940 are displayed in the browser window. As shown in FIG. 9B, the user accesses information pertaining to the employee by clicking the pointing device on the Compliance tab 950, showing that the employee has a current overall compliance percentage of 56.8% 960, a total of sixteen non-compliant items 970 with no upcoming expiration dates 980. A standard compliance report is also included as a sorted listing of the compliance item(s) 971, expiration dates 973, with a yes or no compliant status check box 975, in a column, for each listed compliance item, and a details link 977 to a browser display for information pertaining to each item listed.

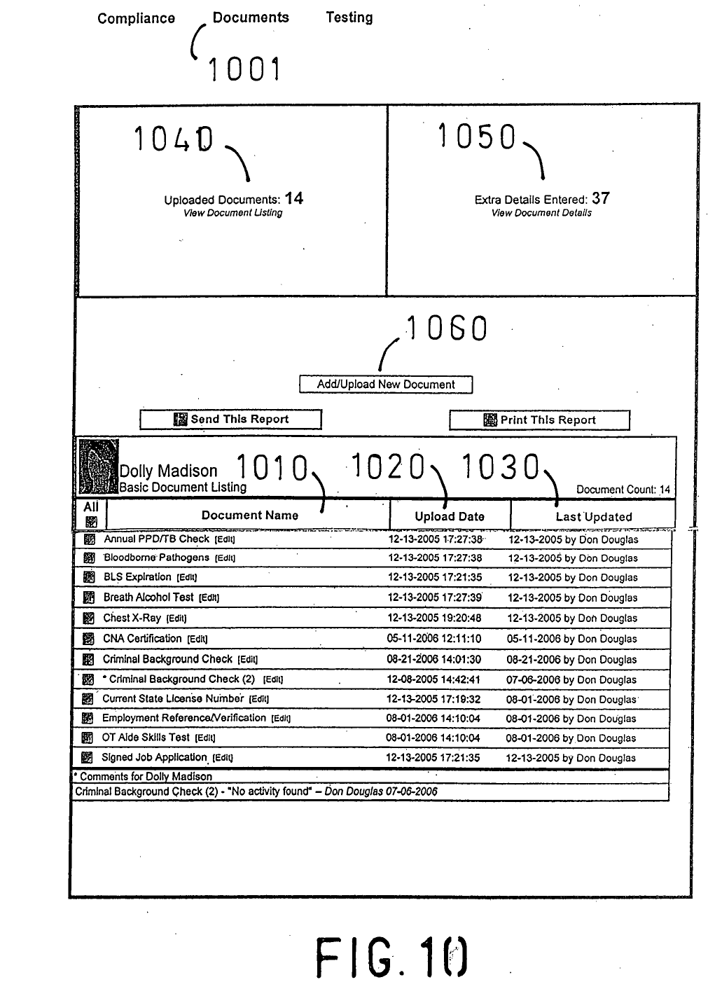

Refereeing now to FIG. 10, using the pointing device, the user clicks on the Documents tab 1001, to view the browser display of the employee's compliant documents in a link listing. Here, the name of the compliant document 1010, the date within which it was uploaded 1020, and date in which each document was last updated 1030, are shown. For example, in this employee's file, fourteen compliant documents have been uploaded 1040 into a file having thirty-seven extra details 1050. In addition, the user may access the browser display link to add or upload a new compliant document by using the pointing device and clicking on the add/upload new document link 1060.

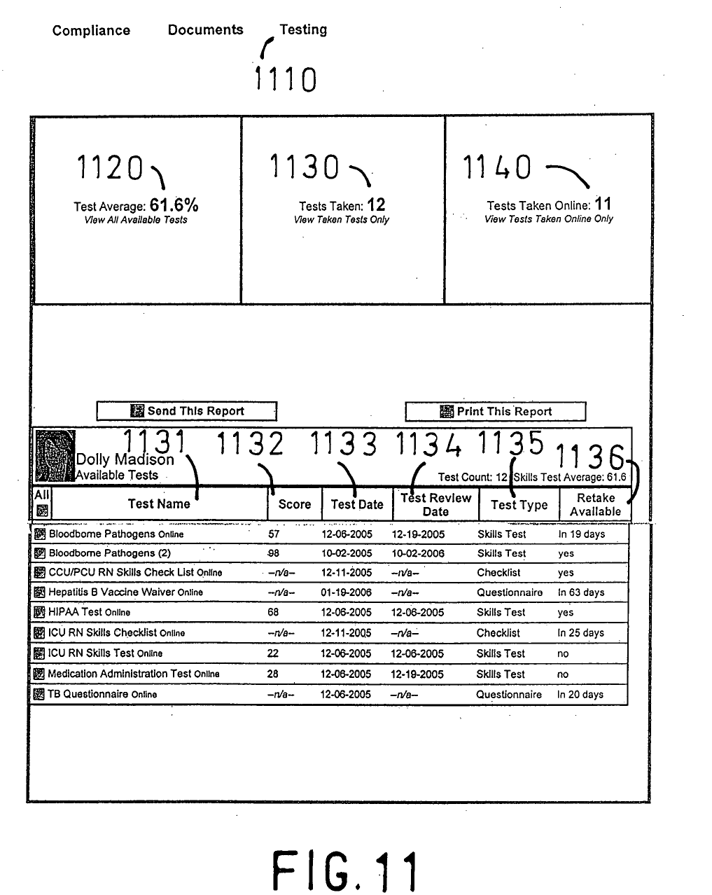

Turning now to FIG. 11, testing is a major component of the overall compliance process to ensure an employee's current compliance. Using the pointing device the user points and clicks on the Testing tab 1110, to view the browser display allowing access to information pertaining to the employee's testing statistics. This display shows that the employee's current test average is 61.6% 1120, that twelve tests have been taken 1130, where eleven of the tests have been taken online 1140. A detailed link list, for each test, is also provided for each individual test name 1131, test score 1132, test date 1133, test review date 1134, type of test taken 1135, with an updated indication as to whether or not the employee is authorized to retake the test 1136. In this example, it is easily determined, from the first row in the list, that the employee scored a fifty-seven on the Bloodborne Pathogens Online Skills test which was taken on 6 Dec. 2005. The test was reviewed on 19 Dec. 2005, and the employee is eligible to retake test in 19 days from the date of the browser display statistic.

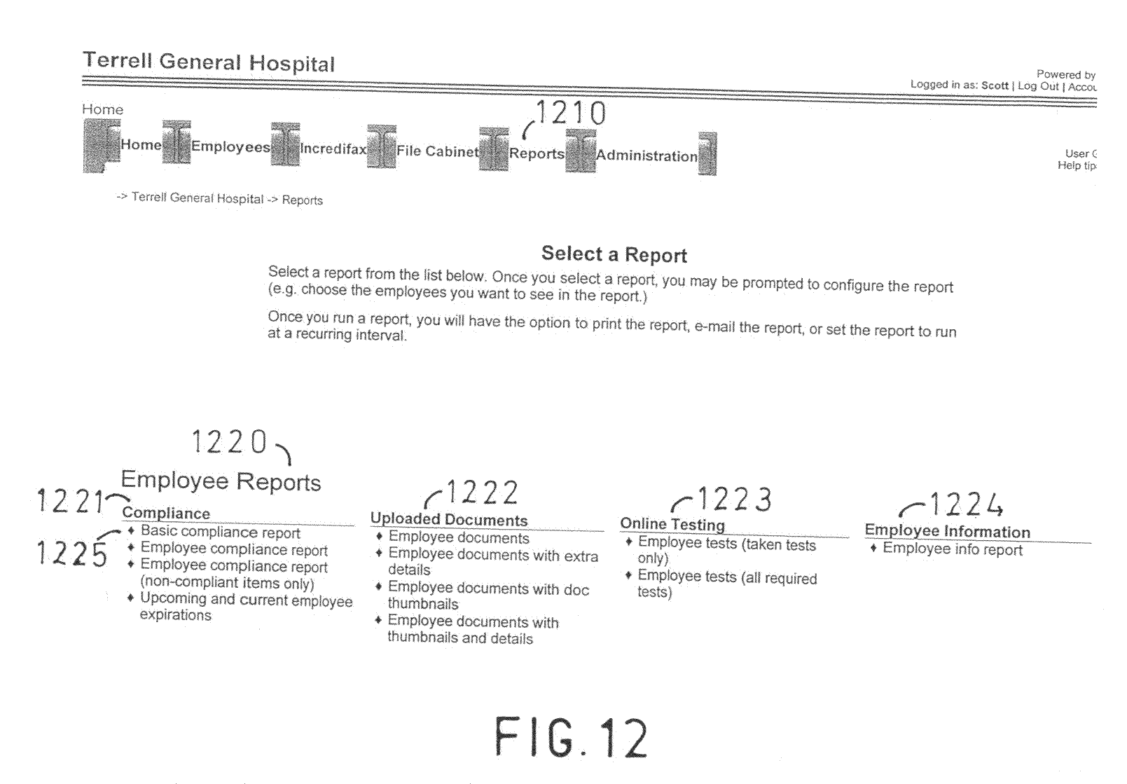

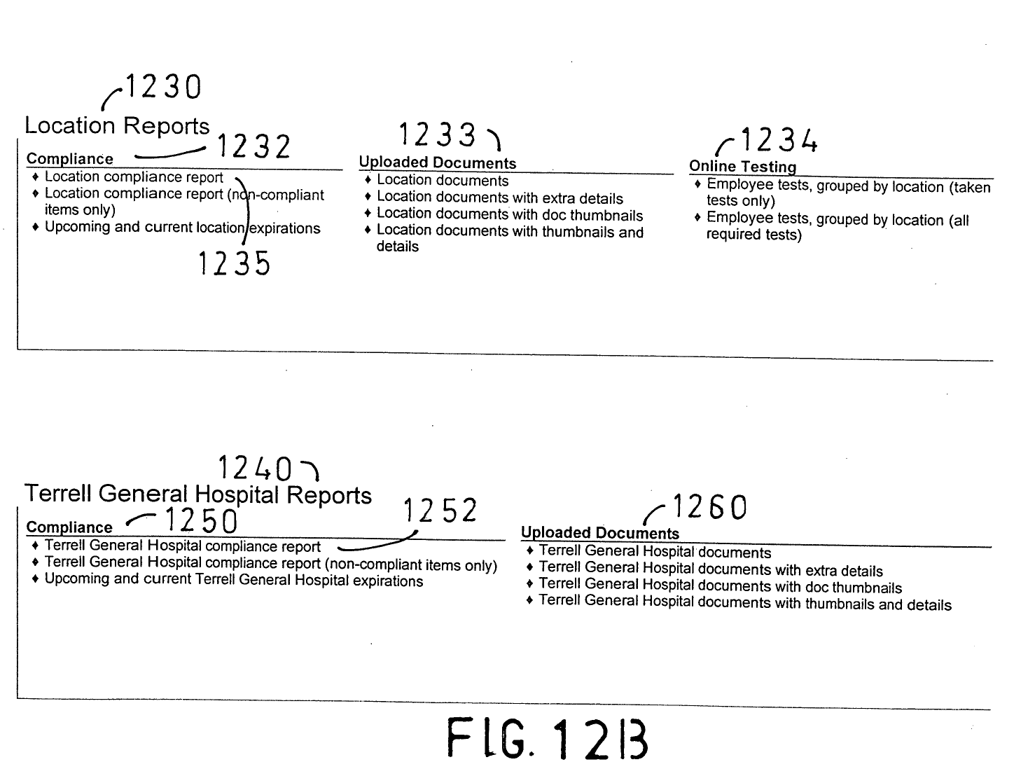

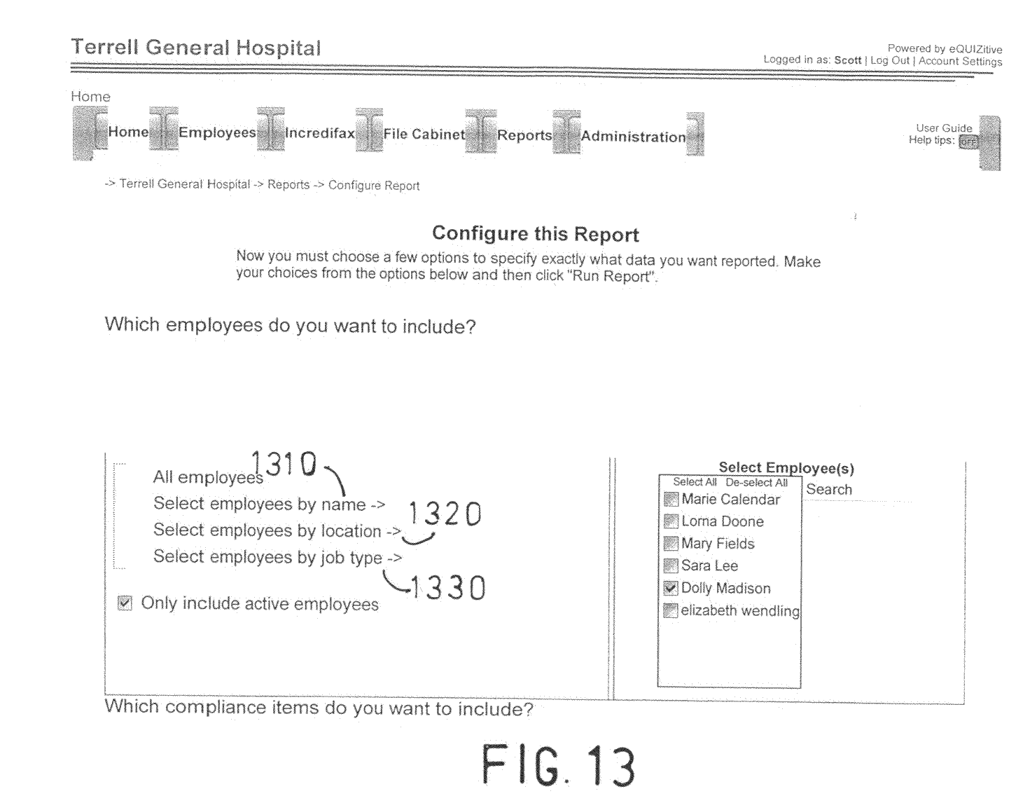

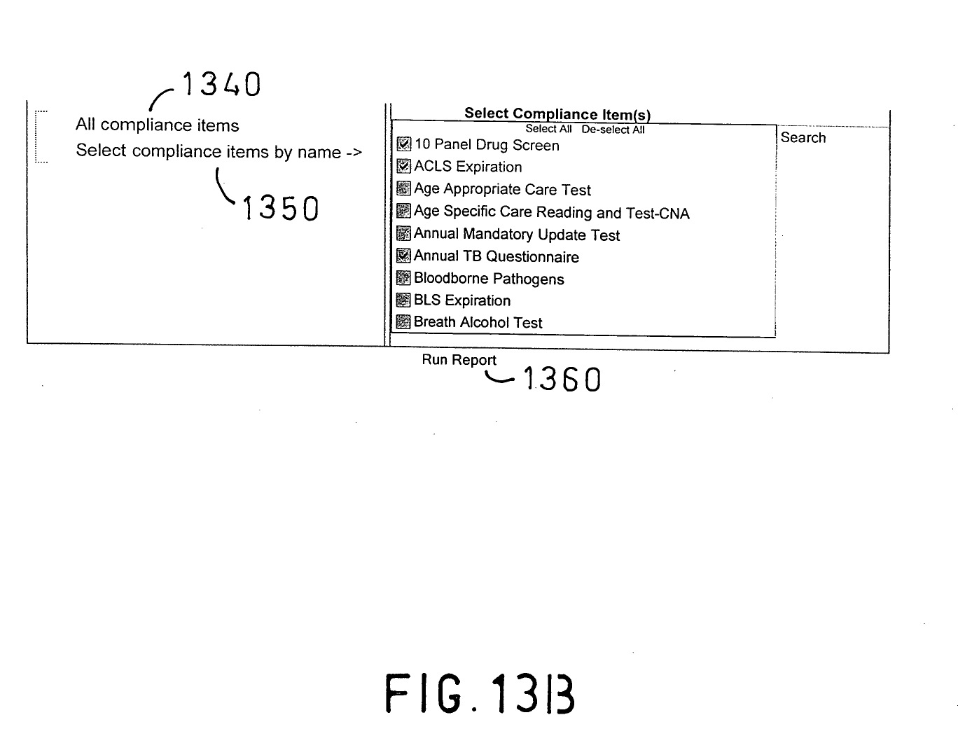

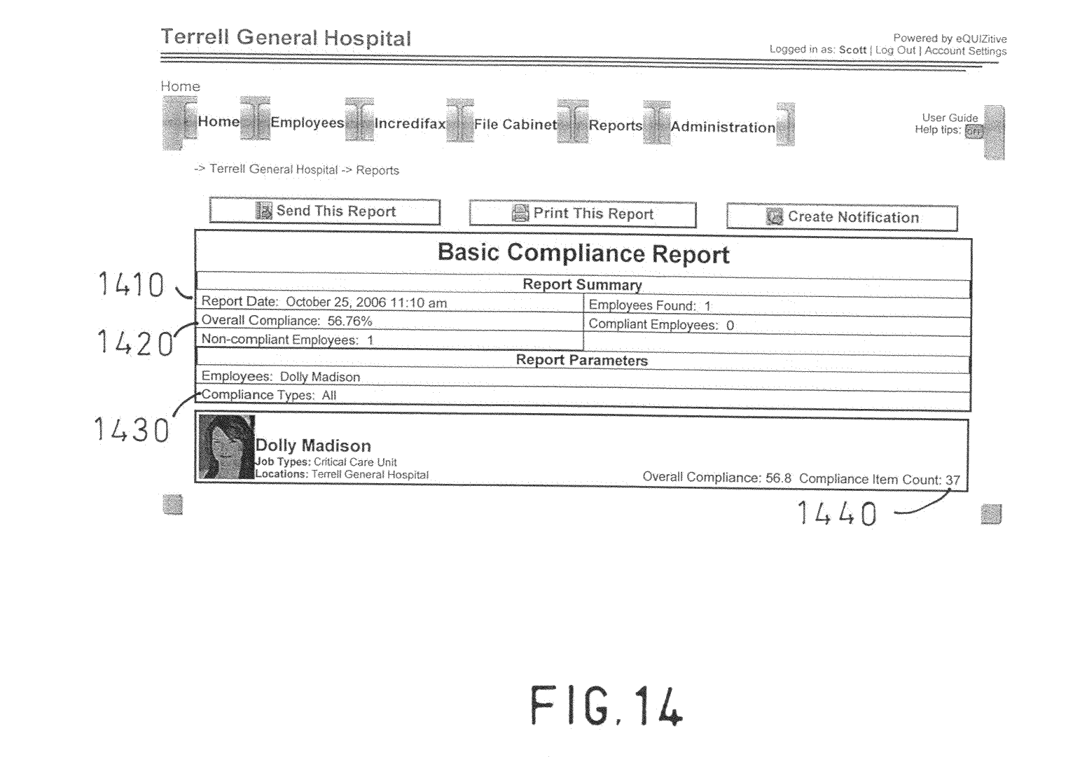

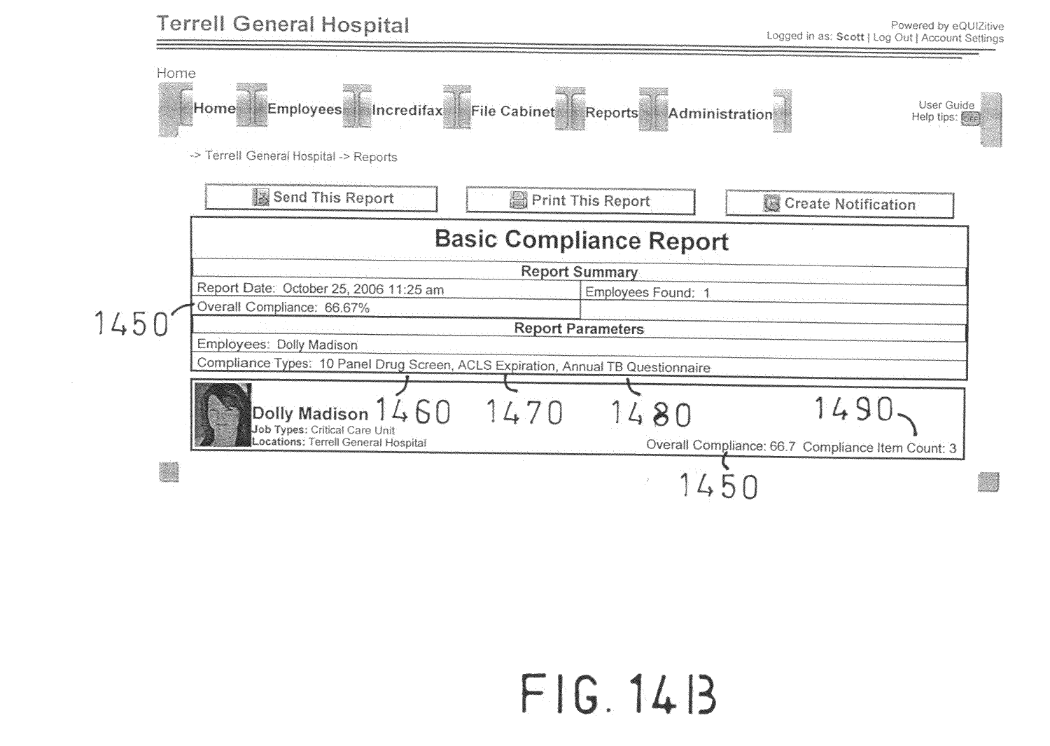

Turning now to FIGS. 12 and 12B, by using the pointing device and clicking on the Report tab 1210, the user has access to the browser display showing information pertaining to a variety of employee 1220, location 1230, or hospital 1240 reports. Each heading provides a linked list for selecting the specific reports and notifications desired. As shown in FIG. 12, the employee reports 1220 are separated into a list of reports for access to information pertaining to employee compliance 1221, uploaded employee documents 1222, employee online testing 1223, and other employee and location information 1224. Under each of the listed headings, is a link list for accessing information pertaining to the desired reports. For example, as shown in FIGS. 13 and 13B, by linking the basic compliance report 1225 under the employee compliance 1221 heading, a browser display having check boxes is first accessed in order for the user to select an employee by name 1310, location 1320, or job type 1330, and a check box for selecting to view all of the compliance items 1340, or a specified compliance items 1350. Using the pointing device, the user clicks on the run report link 1360 to accesses information pertaining to the basic compliance report as shown in the browser display in FIG. 14. As shown in the drawing figure, the accessed report provides a summary of the compliance statistics for the selected employee. In this example, the selected employee, on the report date and time 1410, has an overall compliance statistic of 56.76% 1420 for all 1430 of a total of 37 1440 compliance items. Referring again to FIG. 13B, where the user has selected specific compliance items for report, the example shown in FIG. 14B illustrates that the selected employee, on the report date and time 1410, has an overall compliance statistic of 66.67% 1450, for the 10 panel Drug Screen 1460, ACLS Expiration 1470, and Annual TB Questionnaire 1480, with of a total of three 1490 compliance items on file.

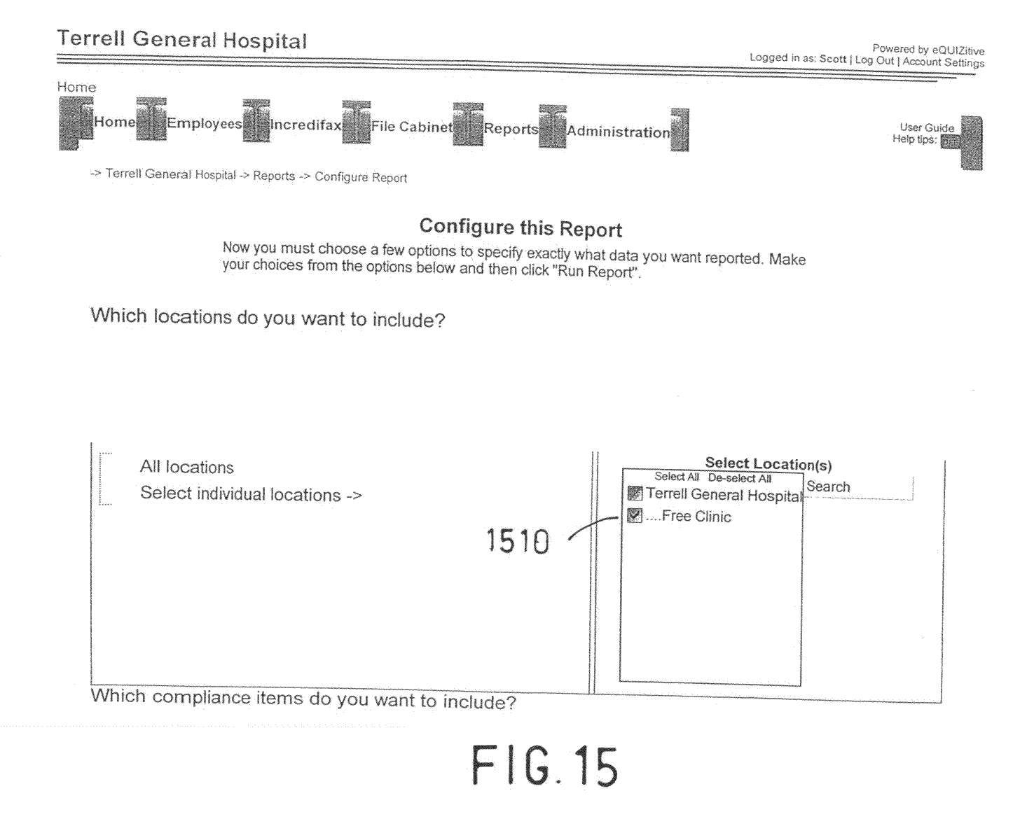

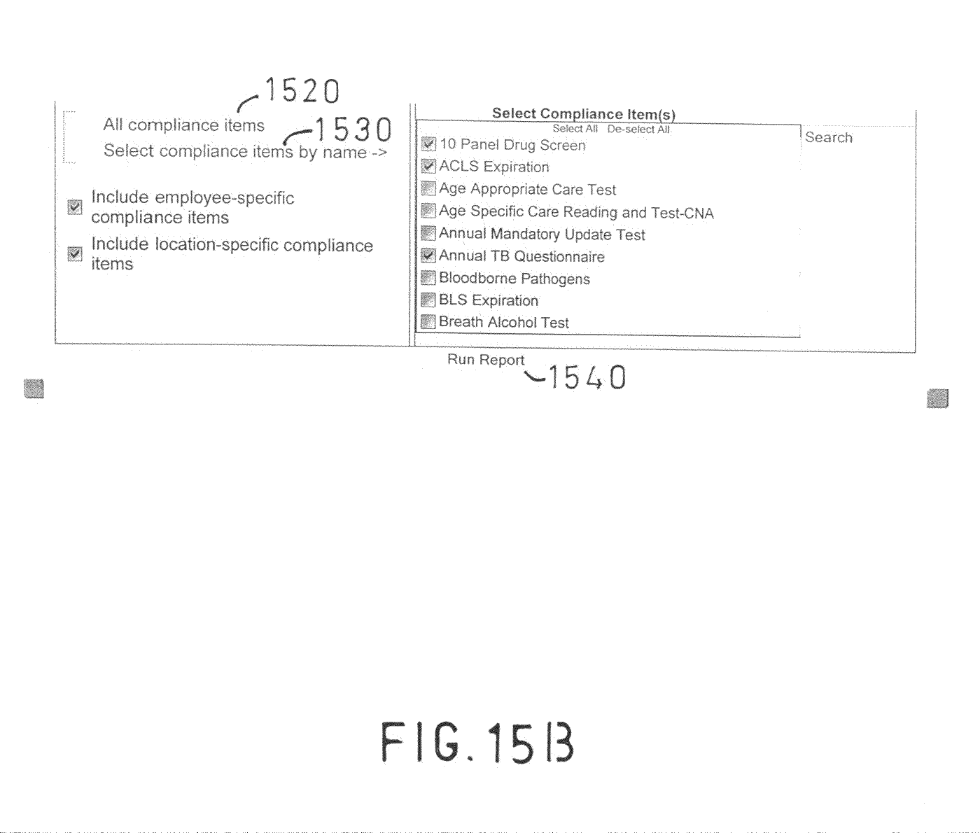

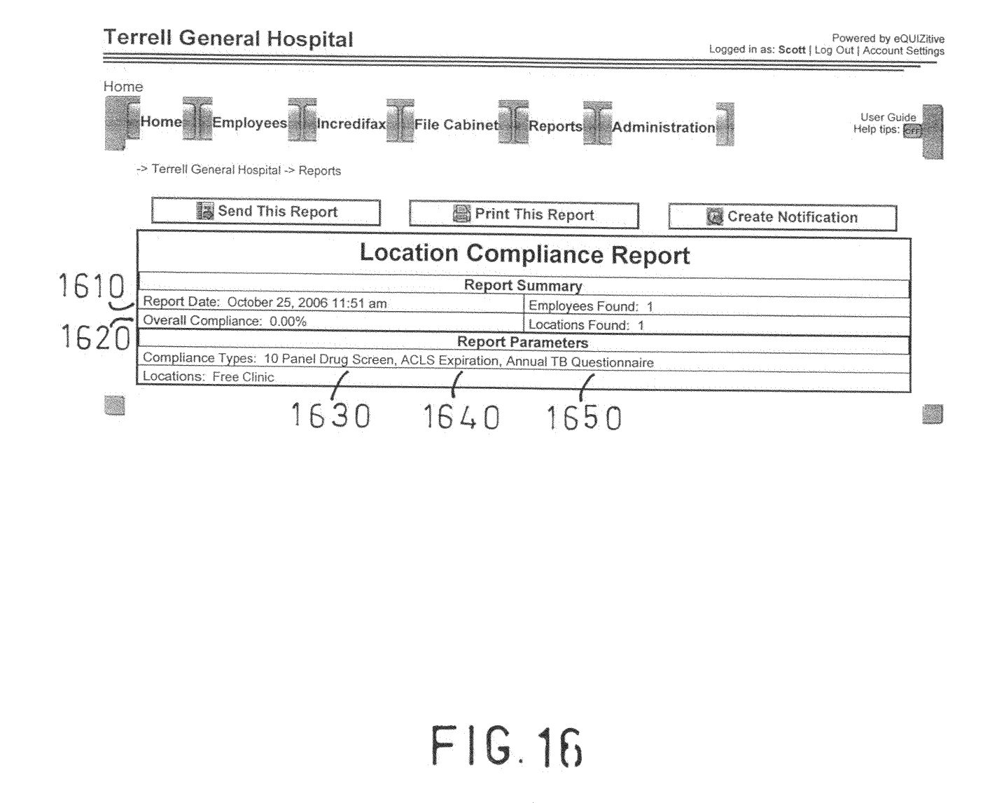

Referring again to FIG. 12B, the Location Reports 1230 include the general link list columns to access information pertaining to location compliance 1232, documents uploaded for a location 1233, and online testing 1234 for a location. For each item in the list, is a link for the user to access information pertaining the desired reports. For example, as shown in FIGS. 15 and 15B, by linking the location compliance report 1235 under the compliance 1232 heading, a browser display having check boxes is first accessed in order for the user to select a location 1510, and a check box for the all 1520 or a specified document compliance items 1530 for which the user desires view and access information. Next, using the pointing device the user clicks on the run report button 1540 and the basic compliance report browser display is accessed for the information shown in FIG. 16. As shown in the drawing figure, the Report provides a summary of the compliance statistics for the selected location and compliance items. In this example, the selected location, on the report date and time 1610, has an overall compliance statistic of 0.00% 1620 for the 10 panel Drug Screen 1630, ACLS Expiration 1640, and Annual TB Questionnaire 1650.

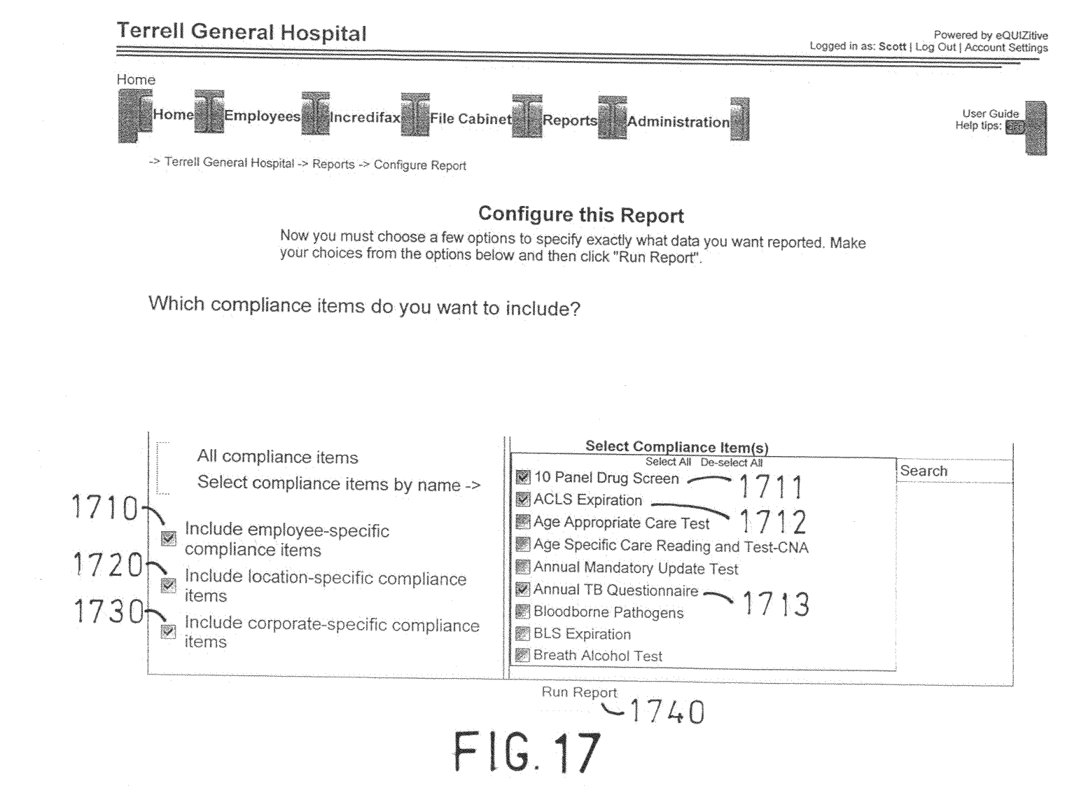

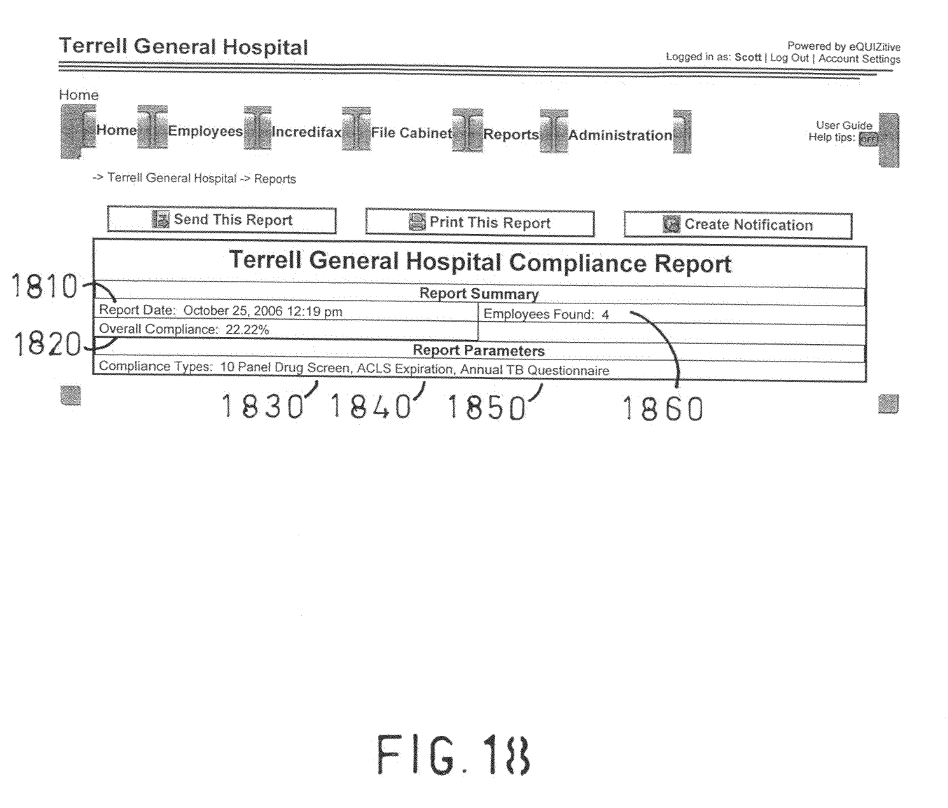

Referring again to FIG. 12B, the hospital reports 1240 include the general column headings having a link list to reports for to access information pertaining to the hospital entities compliance 1250, and compliant documents uploaded for the hospital 1260. Under each of the headings, the user clicks on a link to access the desired report information. For example, by clicking on the hospital compliance report 1252 link, under the compliance 1250 heading, a browser display having check boxes is first accessed in order for the user to access information pertaining to compliance items for the hospital. Referring now to FIG. 17, check boxes are used to access information pertaining to the employee specific 1710, location specific 1720, or corporate-specific compliance items 1730 which the user desires to view. Next, using the pointing device, the user clicks on the run report button 1740 to access the basic compliance report browser display information shown in FIG. 18. As shown in the drawing figure, the hospital compliance report provides a summary of the compliance statistics for the selected compliance items 1711, 1712, and 1713. In this example, for the selected items, on the report date and time 1810, the hospital has an overall compliance statistic of 22.22% 1820 for the 10 panel Drug Screen 1830, ACLS Expiration 1840, and Annual TB Questionnaire 1850, with four employees found 1860.

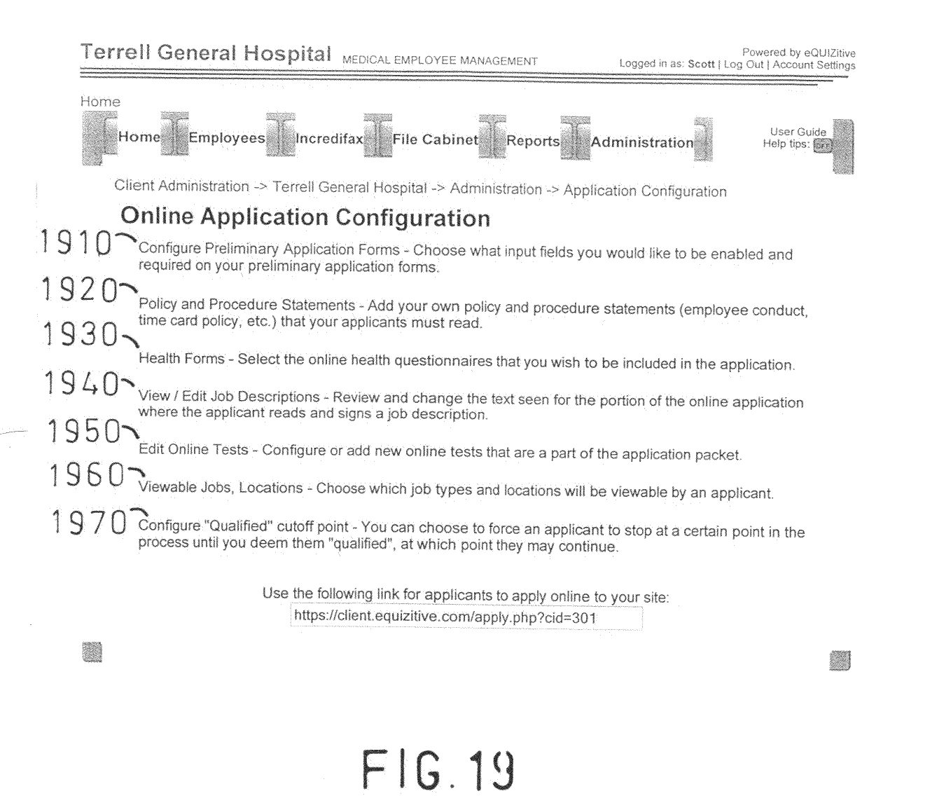

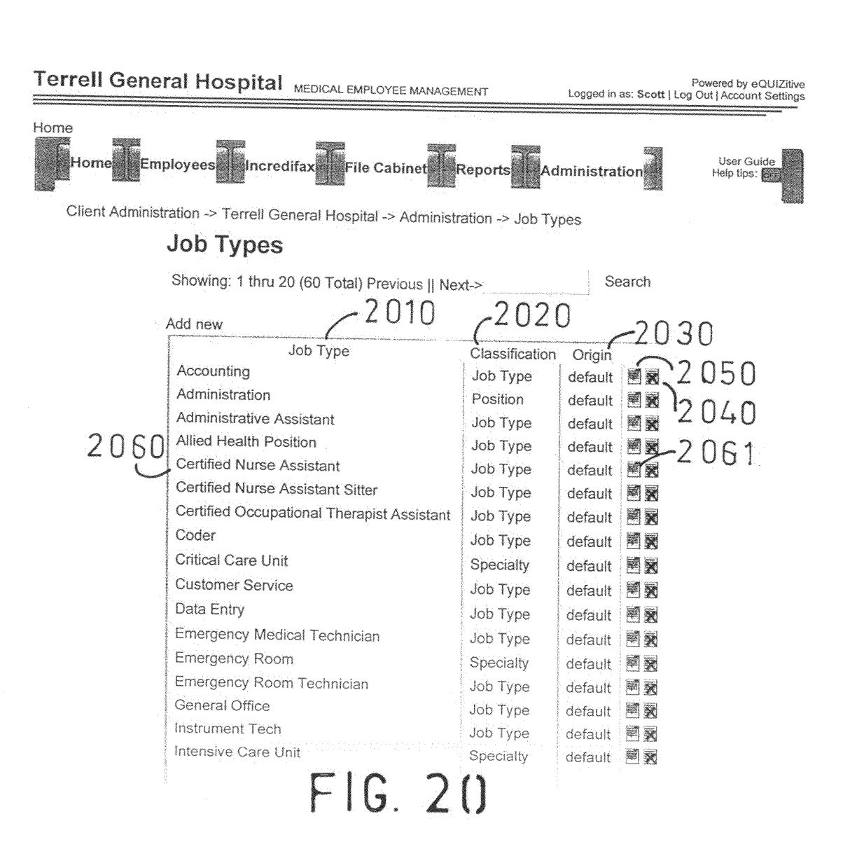

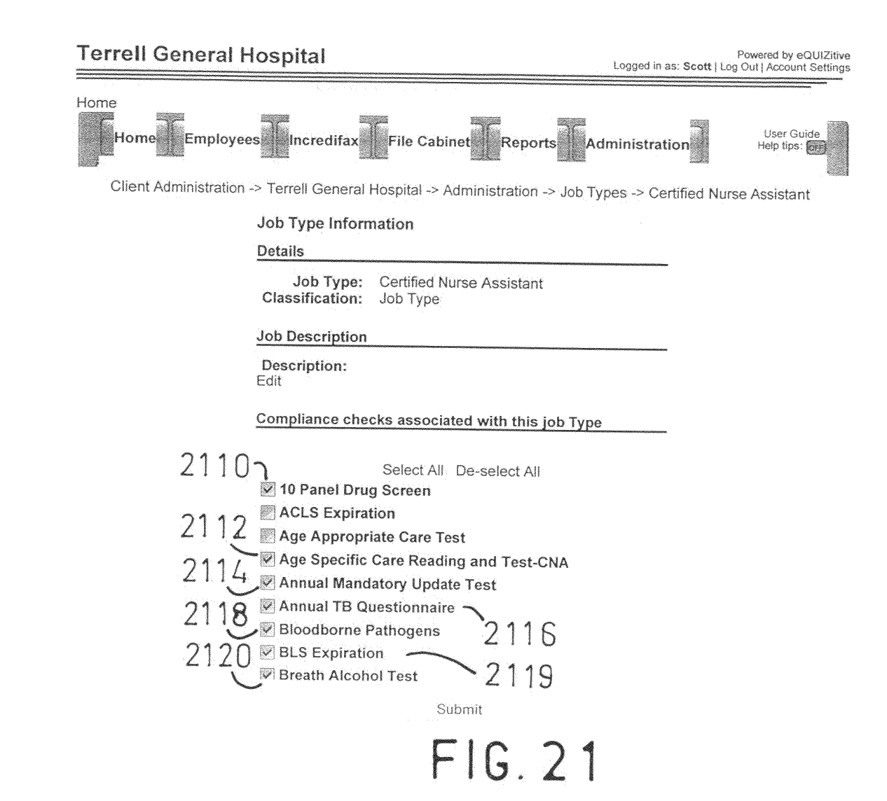

Turning again to FIG. 2, the present invention uses an online employment application for employment hiring and for collecting the required compliance items from the compliance items database using the employee's job designation and location used in determining the compliance statistics. Using the pointing device the user clicks on the Administration tab 60, and, under the customizations heading 230, points and clicks on the online application configuration link 232 to access information pertaining to the employment applications browser display shown in FIG. 19. In the drawing figure, under the online application configuration heading appears a link list for information pertaining to the configuration of the preliminary application forms 1910, preparation of policy and procedure statements 1920, health forms 1930, job descriptions 1940, online tests 1950, job locations 1960, and qualified cutoff points 1970 in order for an applicant to be able to proceed with the hiring process. These data are used in the determination of the compliance statistics for the entity, location, employees and documents types. The system may already be configured with (default) the most common types of jobs and documents for the hospital industry, or the same may be added to the system through customization features. By clicking on the View/Edit Job Descriptions link 1940, in the list, the browser display, shown as FIG. 20, is accessed for information pertaining to all job types 2010, together with each job types classification 2020, and whether or not the origin is by default or customized 2030. For each job type, a make inactive select button 2040 and details information button 2050 are used. For example, by using the pointing device and clicking on the details button 2061, for the listed certified nurse assistant 2060 job type, in the list, the user accesses the browser display for information pertaining to the compliance items required for a certified nurse assistant. As shown in FIG. 21, the check box list of the default compliance items for a certified nurse assistant is used to select those compliance items and data associated with this job description for use in determining the compliance statistics. The user may select from the default list those specific compliance items which are desirable for the individual applicant or location. Here, as shown in the drawing figure, the user has configured the system to use the 10 Panel Drug Screen 2110, Age Specific Care Reading and Test-CAN 2112, Annual Mandatory Update Test 2114, Annual TB Questionnaire 2116, Bloodborne Parthogens 2118, BLS Expiration 2119, and Breath Alcohol Test 2120 for inclusion in the system as required compliance items necessary for the employee to become compliant.

While the present invention has been described in connection with the embodiments as described and illustrated above, it will be appreciated and understood by one of ordinary skill in the art that modifications may be made in the present invention without departing from the true spirit and scope of the invention as described and claimed herein.

We claim:

1. A method for a continuously monitoring a real time compliance statistic, comprising the steps of:
(a) storing a plurality of compliance item data into a central computer;
(b) inputting a job application for an employee into the central computer, the employee having a job designation data and a work location data;
(c) comparing the job designation data, work location data, and compliance item data to determine a plurality of required compliance items;
(d) collecting the required compliance items into a record and storing the record into an employee file;
(e) receiving on a periodic basis a compliant item into the file;
(f) determining a percentage compliance statistic for each of the employee, work location, required compliance items, and compliant items by comparing the required compliance items and the compliant items; and
(g) generating the compliance statistic.

2. The method according to claim 1 wherein the compliance statistic is a percentage of the compliant items compared to the required compliance items for the employee, the location, and the required compliance item.

3. The method according to claim 2 wherein the required compliance item is an online skills test or questionnaire and the compliant item is the online skills test or questionnaire taken or completed by the employee.

4. The method according to claim 3 wherein the compliant item is an authenticated or verified document, online test, or questionnaire.

5. The method according to claim 4 further comprising generating a notification having an expiration date or time for the required compliance items.

6. The method according to claim 5 wherein the file is accessed using a username and password.

7. The method according to claim 1 wherein receiving the compliant item comprises addressing a document, using a facsimile data transmission, to a staging area having a registered telephone number and storing the document from the staging area into the file.

8. The method according to claim 1 wherein receiving the compliant item comprises storing the compliant item into a file folder on an employee remote location computer.

9. The method according to claim 8 further comprising authenticating compliant item document stored on the remote location computer.

10. A computer-implemented apparatus for real-time monitoring of a compliance item percentage statistic of an employee with rules, laws or regulations, the employee being involved in the provision of a regulated service, the apparatus comprising a central processor, a plurality of remote employee computers containing records of required compliance item data having an expiration date and compliant item data sent from the employee on a periodic basis including an authentication data, at least one world-wide-web communication link between the central processor and the plurality of remote employee computers, the central computer including
(a) a storage device for storing records of compliance item data, job application data, job designation data, and work location data, the job application data sent on a periodic basis from the plurality of remote employee computers through the communication link;
(b) a database comparator connected to the storage device for comparing at periodic intervals the compliance item data, job application data, job designation data, and work location data to identify the presence of any required compliance item data which match the records of the job application data, job designation data, and work location data for the employee, the comparator further comparing at periodic intervals the required compliance item data to identify the presence of any compliant item data sent from the employee remote computer which match the required compliant item data to determine the compliance item percentage statistic for the required compliance item data, job designation data, and work location data; and
(c) a report generator connected to the database comparator for generating a report of the compliance item percentage statistic to permit action to be taken in an compliance audit with the rules, laws, or regulations.

11. The apparatus according to claim 10 wherein the employee is employed in a health care or food service industries.

12. The apparatus according to claim 10, wherein the required compliance item data is a skills test or checklist and the compliant item data are the skills test or checklist after completion by the employee.

13. The apparatus according to claim 10, wherein the authentication data is an indicia.

14. A computer-implemented method for real-time monitoring of a compliance item percentage statistic of an employee with rules, laws or regulations, the employee being involved in the provision of a regulated service, the method comprising the steps of providing a central processor, a plurality of remote employee computers containing records of required compliance item data having an expiration date and compliant item data sent from the employee on a periodic basis including an authentication data, at least one world-wide-web communication link between the central processor and the plurality of remote employee computers, the central computer including a storage device for storing records of compliance item data, job application data, job designation data, and work location data;
(b) sending on a periodic basis from the plurality of remote employee computers the job application data through the communication link to the central processor;
(c) comparing with a database comparator connected to the storage device at periodic intervals the compliance item data, job application data, job designation data, and work location data to identify the presence of any required compliance item data which match the records of the job application data, job designation data, and work location data for the employee;
(d) comparing at periodic intervals with the database comparator the required compliance item data to identify the presence of any compliant item data sent from the employee remote computer which match the required compliant item data to determine the compliance item percentage statistic for the required compliance item data, job designation data, and work location data; and
(e) providing a report generator connected to the database comparator and generating a report of the compliance item percentage statistic to permit action in an compliance audit with the rules, laws, or regulations.

15. The method according to claim 14, wherein the employee is employed in a health care or food service industries.

16. The method according to claim 15, wherein the required compliance item data is a skills test or checklist and the compliant item data are the skills test or checklist after completion by the employee.

17. The method according to claim 16, wherein the authentication data is an indicia.
